(19) United States
(12) Patent Application Publication
(10) Pub. No.: US 2007/0264450 A1
(43) Pub. Date: Nov. 15, 2007

(54) REMOVABLE ABSORBENT INSERT FOR FOOD CONTAINER

(75) Inventors: Glenn Josef White, Louisville, KY (US); Esther Chui Lian Ang, Louisville, KY (US); Lonita Marie Barron, New Albany, IN (US); Edward W. Rider, State Hill, NY (US)

Correspondence Address: KNOBBE MARTENS OLSON & BEAR LLP, 2040 MAIN STREET, FOURTEENTH FLOOR, IRVINE, CA, 92614, US

(73) Assignee: KFC Corporation, Louisville, KY (US)

(21) Appl. No.: 11/747,833

(22) Filed: May 11, 2007

Related U.S. Application Data
(60) Provisional application No. 60/800,165, filed on May 12, 2006.

(51) Int. Cl. B31B 45/00; B32B 3/10; B65D 39/00

(52) U.S. Cl. 428/34.1; 428/36.5; 428/131

(57) ABSTRACT

An absorbent insert for a food container can be made of a three layer expanded foam material. The expanded plastic foam material comprises bottom and top layers having a closed cell structure and a middle layer having an open cell structure. The top layer has apertures formed in it such that liquids can pass through the top layer and into the middle layer. The middle layer can have a surfactant that attracts and retains grease or other drippings. The insert can be sized to fit within a food container.

### CROSS-REFERENCE TO RELATED APPLICATIONS

This Application claims priority to U.S. Provisional Patent Application Ser. No. 60/800,165, filed May 12, 2006 and entitled “REMOVABLE ABSORBENT INSERT FOR FOOD CONTAINER”, the entirety of which is incorporated herein by reference.

### BACKGROUND OF THE INVENTION

1. Field of the Invention

This application relates to food containers and, more particularly, to the use of an absorbent insert or bottom member for placement in a heated-food container to absorb hot drippings, grease, other liquids or a combination of such liquids within the food container.

2. Description of the Related Art

Restaurants, particularly quick service restaurants, often serve food in containers designed to allow a customer to take the food out of the restaurant for later consumption. Food containers are often made of a rigid or expanded plastic material such as polystyrene or a fiberboard material, which in some applications is coated to prevent leakage. Both of these materials prevent fluids from leaking out of the container, but have the disadvantage of allowing liquids to collect within the container. The collection of liquid within the container can result in soggy or greasy food.

European Patent Publication No. 0090507A1, dated May 10, 1983, listing Wu as the inventor, describes a clamshell style container made of two layers of an expanded foam material. The layer of material on the outside surface of the container is an expanded foam having a closed cell structure. The layer of material on the inside surface of the container is an expanded foam having an open cell structure. The open cell foam material can absorb liquids such as vapor which rises and collects on the interior of the closed lid of the container. The closed cell layer prevents leakage. However, this system is limited to containers made entirely of the two layer material including both the closed cell layer and the open cell layer. In addition, the food rests directly against the open cell foam layer which soaks up excess liquid. Thus, the food is not well protected from the excess liquid and/or grease.

U.S. Pat. No. 5,618,853, issued to Vonken et al. on Apr. 8, 1997, describes the construction of a sheet of expanded foam having a generally open cell structure (i.e. a mixture of open and closed cells but cells that retain structural strength by minimizing the breakage) where a layer on the top surface of the sheet has a closed cell structure and a layer on the bottom surface of the sheet also has a closed cell structure. In the disclosed expanded plastic foam structure, the layer of expanded foam with an open cell structure is interposed between the pair of non-porous skins. Each of the skins is formed of a layer of cells of expanded foam.

### SUMMARY OF THE INVENTION

In some embodiments, a removable absorbent foam insert can be placed in a container for carrying hot food. The insert comprises a three layer expanded foam material having a bottom layer with a closed cell structure, a middle layer with an open cell structure, and a top layer with a closed cell structure. A surfactant is contained in the middle layer. Apertures extend through the top layer and into the middle layer to permit liquids (e.g., hot drippings) to enter into the middle open cell layer where the liquids can be absorbed. At least the top layer is formed of a material sufficient to withstand the temperature of hot food placed into the container.

In accordance with one preferred form of the insert, the top surface of the removable absorbent foam insert comprises raised areas and non-raised areas. The raised areas elevate the food allowing excess liquids such as grease to collect in the non-raised areas where they can then be absorbed by the foam insert. The apertures are located at least in the non-raised areas. In accordance with another preferred form of the insert, a perimeter edge of the foam insert is defined at least in part by the open cell structure to permit liquid to enter the middle layer.

Another aspect includes food storage system comprising a container having a body and a lid. The lid cooperates with the body to inhibit hot food within the container from cooling. The container body also includes a base. At least one removable absorbent foam insert is disposed within the container body on the base. The insert has a size and shape that at least generally matches the size and shape of the container base. The insert is formed of at least an inner absorbent layer and an outer layer that increases the heat resistance of the base. At least a portion of the inner absorbent layer is exposed to the exterior of the insert to permit drippings from hot food within the container to be absorbed by the inner layer.

In accordance with a preferred method of packaging a heated comestible, a container is provided that has a base and at least one upstanding wall. An insert is placed within the container and is positioned against the container base. The hot comestible (e.g., grilled chicken pieces) is placed on top of the insert until the container is full. A lid is closed and engages with the container to hold the hot comestible within the container.

In some embodiments, a foam insert for a food container comprises a first layer, a second layer, and a third layer. The first layer is comprised generally of a closed cell foam. The second layer is comprised generally of an open cell foam. The third layer is comprised generally of a closed cell foam. The third layer comprises a plurality of apertures formed therethrough. The second layer is positioned between the first and third layers. The foam insert is sized and configured to be removably inserted into the food container.

In other embodiments, a food storage system comprises a food container and a removable absorbent insert. The removable absorbent insert is sized and configured to fit within the food container. The insert comprises a first layer and a second layer. The first layer is comprised generally of a closed cell foam material. The second layer is comprised generally of an open cell foam material. The first layer comprises a plurality of apertures therethrough.

### BRIEF DESCRIPTION OF THE DRAWINGS

These and other features, aspects, and advantages of various embodiments of the inventions will now be briefly described. The illustrated embodiments, however, are merely exemplary and are not intended to be limiting. The drawings include the following thirteen figures.

FIG. 1 depicts a perspective view of the top surface and a portion of the perimeter surface of a removable absorbent insert for a food container.

FIG. 2 depicts a view of the top surface of the removable absorbent insert of FIG. 1.

FIG. 3 depicts a view of the bottom surface of the removable absorbent insert of FIG. 1.

FIG. 4 depicts an elevation view from the perimeter of the removable absorbent insert of FIG. 1.

FIG. 5 depicts the removable absorbent insert of FIG. 1 in place in a food container.

FIG. 6 depicts a cross sectional view of the removable absorbent insert of FIG. 2.

FIG. 7 depicts an expanded view of a portion of the cross section of the removable insert shown in FIG. 6.

FIG. 8 depicts a top view of another embodiment of absorbent insert for a food container.

FIG. 9 depicts a cross-sectional view of the insert of FIG. 8 taken along line 9-9.

FIG. 10 depicts an expanded view of the cross-section of the removable insert shown in FIG. 9.

FIG. 11 depicts a top view of another embodiment of absorbent insert for a food container.

FIG. 12 depicts a cross-sectional view of the insert of FIG. 11 taken along line 12-12.

FIG. 13 depicts an expanded view of the cross section of the removable insert shown in FIG. 12.

### DETAILED DESCRIPTION OF THE PREFERRED EMBODIMENT

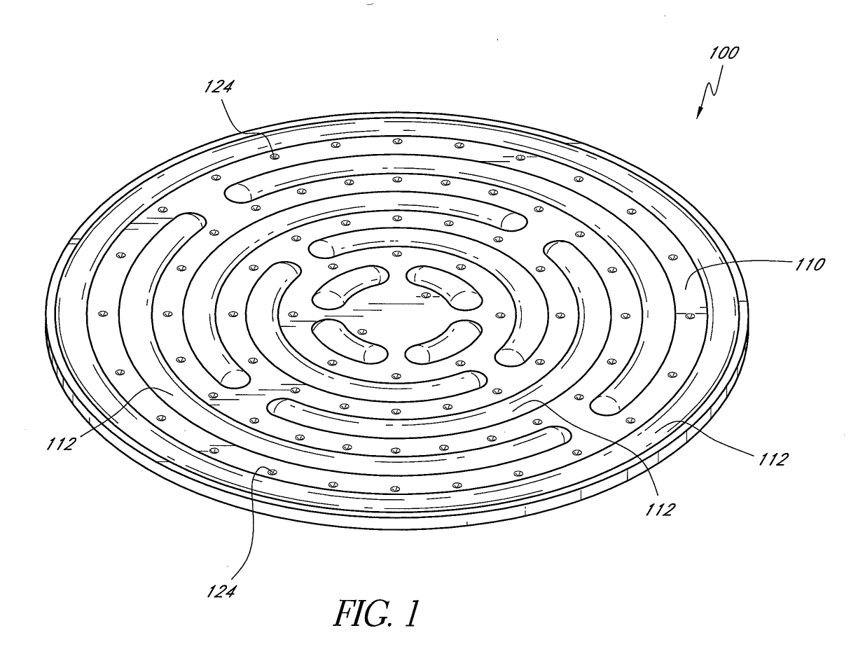

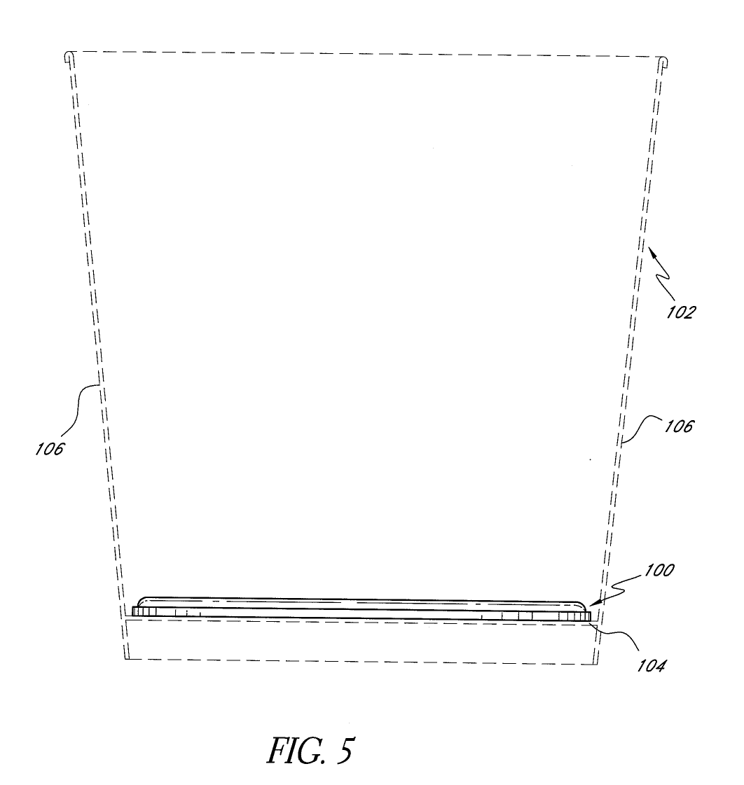

In the embodiment shown in FIG. 1, the absorbent foam insert 100 comprises a sheet of foam that is impregnated with a surfactant and is configured to fit within a container 102 designed to hold hot foods (e.g., grilled chicken pieces). FIG. 5 shows an embodiment of the absorbent foam insert 100 placed in a bucket style food container 102. While the absorbent foam insert 100 has particular utility when placed at the bottom of a food container 102, the insert can also be used to be disposed at other locations within the container, for example, but without limitation, in a lid of the container to absorb steam produced by the hot food within the container. For the sake of simplicity, however, the embodiment of absorbent foam insert 100 will be described for use at the bottom of the food container 102.

The absorbent foam insert 100 preferably is shaped according to the dimensions of the food container 102 with which it will be used. In the embodiment shown in FIG. 5, the food container is a bucket with a circular base. Accordingly, the insert 100 has a circular perimeter to correspond with a base 104 of the container 102. In other embodiments the absorbent foam insert 100 may be configured for use with food containers of other shapes having any number of differently shaped bases, such as, for example, square, octagonal, oval, triangular, or circular. Accordingly, in those embodiments the insert 100 preferably would have a shape corresponding with the shape of the base of the container.

The absorbent foam insert 100 preferably is also sized to be generally coextensive with the inner surface area of the base 104 such that only a small gap, if any, exists between an upstanding wall(s) 106 of the container 102 and the insert 100. For containers 102 in which the upstanding wall(s) 106 slants away from the base 102 (an example of which is shown in FIG. 5), the insert 100 can have substantially the same size (e.g., diameter) of the base 104.

Different embodiments of the absorbent foam insert 100 can be used with hot food containers 102 of all types and materials. For example, the insert 100 can be used with any one of various container styles, such as, for example, bucket, clamshell, or carton styles. The container 102 also can be made of various materials, including, paperboard, cardboard, expanded plastics, foams, etc., with or without coatings, which have heat resistant properties. Thus, the containers 102 in which the insert 100 is designed to be used can be configured to contain numerous types of hot foods.

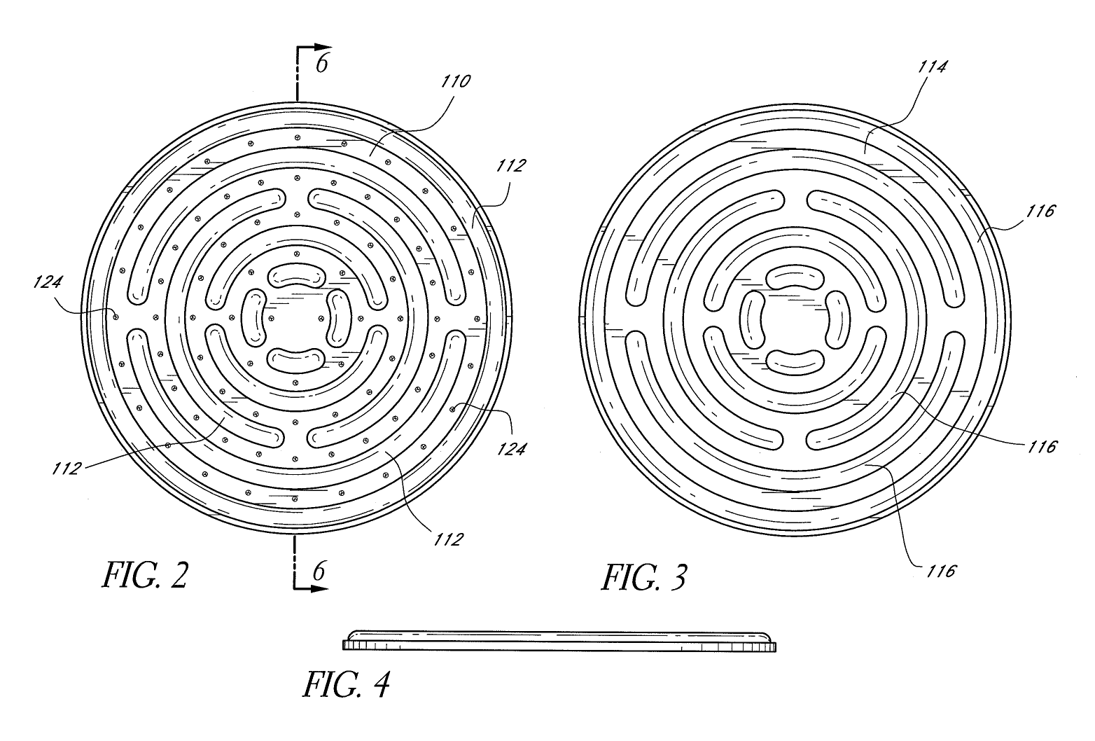

As seen in FIGS. 1 and 2, the top surface 110 of the absorbent foam insert 100 preferably includes comprises raised standoffs or areas 112 to support the food above at least portions of the top surface 110. In the illustrated embodiment, the standoffs take the forms of arcuate ribs 112 that project above the top surface 110 of the insert 100. FIG. 6 further depicts the ribs 112 in a cross-sectional view. The raised ribs 112 help to prevent food in the container from coming in contact with excess liquids which are to be absorbed by the foam insert. The raised ribs 112 also aid in making the food in the container less greasy and soggy as they allow excess oils, fat, water, and other drippings to drip off of the food into the lower areas where the body of the foam insert 100 can absorbed such drippings. For example, when used in a bucket style container 102 for grilled chicken, the raised ribs 112 of the absorbent insert 100 elevate the pieces of chicken slightly above the top surface 110 of the insert 100 and above the bottom of the container 102. Excess grease and like drippings can drop off the pieces of chicken and collect in the lower areas of the absorbent foam insert 100 resulting in chicken that is less soggy and greasy. The absorbent insert 100 can have similarly benefits with many other types of food.

In the embodiment shown in FIGS. 1 and 2 the raised ribs 112 are arranged as generally concentric circles with the center of the circles being approximately the center of the absorbent foam insert 100. As shown in FIGS. 1 and 2, the outermost raised ribs 112 comprises a complete circle; however, the inner, circular raised ribs 112 include breaks or discontinuities in the circle (that is, parts of the circle are not raised). In the embodiment shown in FIGS. 1 and 2, the inner most raised circle has four breaks spaced at approximately equal intervals around the circle. The raised circles between the inner circle and the outer circle each have two breaks which are approximately spaced so as to divide each raised circle into two halves. The breaks in the raised circles are located in different locations so that the breaks points are not arranged along a single line. This configuration of raised ribs 112 is merely one of many configurations that can be used. For example, in another embodiment, the raised areas could be arranged as a number of straight lines across the surface. In yet another embodiment, the raised areas could be arranged as sets of intersecting lines across the surface. Many other configurations can be used, and it will be appreciated that certain configurations may work better than others for the size and shape of a particular food item and/or a particular container.

As depicted in FIGS. 4, 6, and 7, in a preferred embodiment, the raised ribs 112 extend above the top surface 110 of the non-raised areas by a distance approximately equal to the thickness of the flat, un-molded sheet of expanded foam. In other embodiments, the raised areas may extend a larger or smaller distance above the surface of the non-raised areas.

It will be appreciated that although the embodiment depicted in FIGS. 1 and 2 is described as having raised areas and non-raised areas, the same results could be achieved by having recessed areas and non-recessed areas. Accordingly, when referring to the top surface of the absorbent insert the term non-raised area is defined to include recessed areas. Correspondingly, when referring to the top surface of the absorbent insert the term raised area is defined to include non-recessed areas.

With reference to FIG. 3, in one embodiment a bottom surface 114 of the absorbent foam insert 100 comprises recessed areas 116 corresponding with the raised ribs 112 on the top surface 110 of the foam insert 100. The recessed areas 116 on the bottom surface 114 of this embodiment can be seen further in FIG. 6, which depicts the insert 110 in cross section. In other embodiments, the bottom surface 114 could be substantially flat with no recessed areas or the bottom surface could instead have raised areas similar to the raised areas found on the top surface 110 of the embodiment shown in FIGS. 1 and 2.

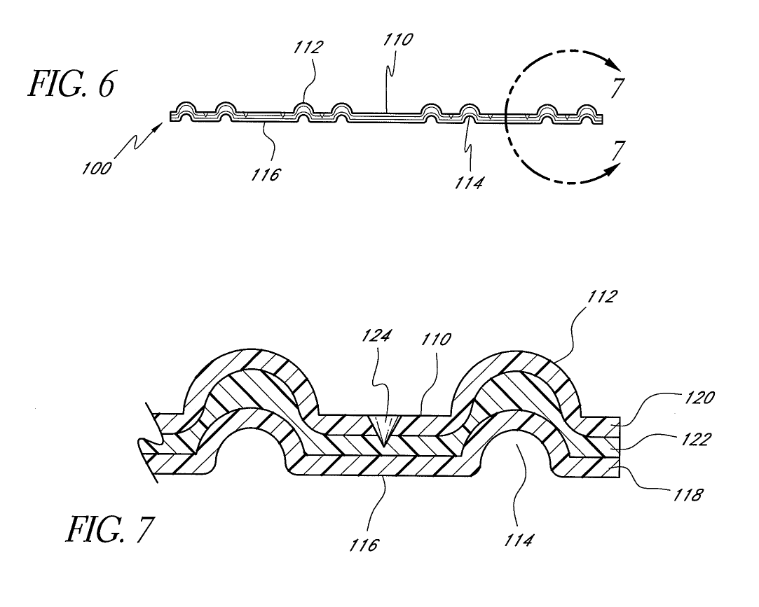

With reference to FIG. 7, the absorbent foam insert 100 preferably comprises three or more layers of an expanded foam material, such as, for example, but without limitation, polystyrene or like polymers. Additionally, the insert can be formed of layers of differing material types. The material and manufacturing techniques used preferably produce an insert 100 with at least the top layer of material being resistant to heat at temperatures greater than 100° F. (37° C.), more preferably resistant to heat at temperatures greater than 120° F.(49° C.), and most preferably resistant to heat at temperatures greater than 140° F. (60° C.). The heat resistant qualities of the insert 100 supplement or provide the thermal resistances of the material forming the base or bottom of the hot food container 102.

The bottom layer 118, or first layer, and the top layer 120, or third layer, preferably comprise an expanded foam material having a generally closed cell structure. The middle layer 122, or second layer, comprises an expanded foam material having generally an open cell structure. The top and bottom layers 118, 120 of material having a closed cell structure can be thinner than the inner layer 122 of material having an open cell structure, as illustrated in FIG. 6. Alternately, each of the top and bottom layers 118, 120 may be of equal thickness or thicker than the inner layer 120. The top and bottom layers 118, 120 can also have differing thicknesses. Additionally, the top and bottom layers 118, 120 can each have a thickness of only one or a few cells, provided that the outer surface of each layer 118, 120 forms a generally closed barrier to retain at least most of the absorbed liquids. In other embodiments, it is appreciated that the insert or bottom member can be formed of a layered structure having multiple layers of open cell foam and multiple layers of closed cell foam.

In addition, the middle layer 122 is formed with a surfactant combined with (e.g., embedded into) the open cells. The surfactant preferably has an affinity for at least animal greases and fats. One suitable surfactant for use with grilled chicken, which is commercially available, is Clariant CESA-Extend OMAN 698470 (30% Active). The surfactant is added to the middle open cell layer 122 either prior to or after foaming.

In the illustrated embodiment, the peripheral edges of each layer 118, 120, 122 remains exposed. This construction permits drippings and other liquids within the container to be absorbed into the middle layer 122 through its open perimeter edge(s).

A variety of methods of producing a sheet of material comprising three layers of expanded foam with a surfactant, as described above, are known to those of skill in the art. For example, methods described earlier in this disclosure may be used. Alternately, the material may be purchased from Trapla, S. A. DE CV of Granda, Mexico as Absorbent Polystyrene Foam APF-43 (Espuma de Poliestirno Absorbente APF-43).

With this construction, the middle layer 122 of material, which has an open cell structure, can absorb liquids such as water and grease. By contrast, the bottom and top layers 118, 120 of material, which has a closed cell structure, generally block liquids and are not absorbent. Accordingly, the bottom and top layers 118, 120 function to help contain liquids absorbed by the middle layer 122. That aids in preventing the food container from leaking. In addition, the top layer 120 of closed cell material helps to insulate and protect the food from the liquids absorbed by the middle open cell layer 122.

With reference again to FIGS. 1 and 2, small apertures 124 preferably are formed through the top layer 120 of closed cell material. As can be seen in FIGS. 6 and 7, the apertures 124 extend from the top surface 110 of the absorbent insert 100 through the top layer 120 of closed cell material and into the middle layer 122 of open cell material. These apertures 124 allow liquids to travel from the top surface 110 of the absorbent insert 100 into the absorbent middle layer 122 of material. The apertures 124 are located in the non-raised areas on the top surface 110 of the absorbent insert 100. Thus, liquids such as excess water, oil, and grease that collect in the non-raised areas can flow into the absorbent middle layer 122 of the surfactant-doped open cell material.

The apertures 124 can have various shapes, such as, for example circular, triangular or square. Each aperture 124 preferably has a size 124 sufficient to permit the ingress of hot drippings into the insert 100 while restricting the egress of such drippings from the middle layer 122. In one example, each aperture 124 has a size not greater than 0.155 in², more preferably a size not greater than 0.125 in², and most preferably generally equal to 0.100 in². Each aperture 124, however, preferably is not smaller than 0.025 in² to permit hot grease and drippings to flow into the insert 100.

The number and arrangement of apertures 124 on the upper surface 110 of the insert 100 preferably is configured to promote a generally even distribution of apertures over the upper surface 110 of the insert 100. In this manner, the absorption capability of the insert 110 can be maximized. The apertures 124, as noted above, also preferably are arranged on the non-raised areas of the upper surface 110. Drippings that pool between the ribs 112 thus tend to evenly disperse over the non-raised areas and drain through the apertures 124 into the middle layer 122. In the illustrated embodiment, there are approximately 2 apertures per each in² of surface area on the top surface 110; however, the number holes per a given surface area can vary between 2 holes per in² and 20 holes per in².

With reference to FIG. 5, in one embodiment the absorbent insert 100 is sized to fit within a corresponding food container 102 such that some amount of space is left between the outside edge of the absorbent insert 100 and the interior surface of the walls 106 of the food container 102. This allows liquid to reach the absorbent, middle layer 122 of open cell material in the insert 100 through the perimeter edge of the insert. As noted above and as seen in FIG. 4, the middle layer 122 of open cell material is exposed along the perimeter of the absorbent insert 100. Accordingly, liquids that reach the perimeter of the absorbent insert 100 can enter the middle layer of open cell material through the perimeter.

In one application, the method of producing the absorbent foam insert 100 begins with a sheet of expanded foam having three layers and surfactant as described above. The sheet of expanded foam is molded using a thermo-former to achieve the raised areas (e.g., the ribs 112) described above. After molding, the absorbent inserts 100 are cut from the sheet in the appropriate shape and size for the desired food container. Alternatively, the inserts 100 can be formed in the general desired shape and then trimmed. Holes are formed (e.g., by punching) in the top layer 120 of closed cell material in accordance with any one of the methods well known to those of skill in the art, such as the methods described in U.S. Pat. No. 5,720,915 issued on Feb. 24, 1998 to Joppen et al.

In other embodiments, the absorbent foam layers 118, 120, 122 may be an integral part of the food container, for example, be the bottom member of the food container. In one embodiment the absorbent foam insert is integrally formed with the food container so that it forms the base of the container.

In still another embodiment, the entire food container may comprise the three-layer expanded foam material described above. In that embodiment, at least a portion of the interior surface of the base of the container includes holes extending through the layer of closed cell material on the interior surface of the container into the middle layer of open cell material. In addition other portions of the container may also include holes extending from the interior layer of closed cell material into the middle layer of open cell material. An embodiment of this type can be produced using a process similar to the process described above for producing an absorbent insert. A sheet of three layer expanded foam is cut into appropriately sized pieces and is thermo-form molded into the appropriate shape for the container. The containers are then trimmed. Holes are punched in the inside surface of the container as needed.

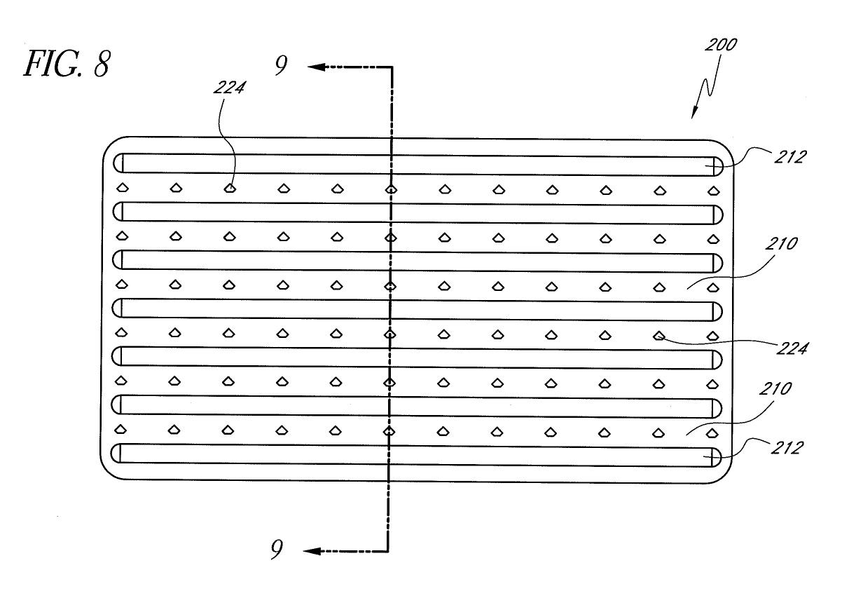

With reference to FIGS. 8-10, another embodiment of absorbent insert is illustrated. In the illustrated embodiment, the insert 200 is configured for placement in a food container comprising a generally rectangular prismatic box. Thus, the insert 200 can have a substantially rectangular surface. With reference to FIG. 8, in the illustrated embodiments, the insert 200 has a generally rectangular surface with rounded corners. It is contemplated that in other embodiments, a generally rectangular insert could have square corners.

Similar to the insert described above with respect to FIG. 1, in the embodiment of FIG. 8, the insert 200 can comprise a plurality of raised areas 212 or ribs and a plurality of non-raised areas 210. As further discussed below, a plurality of apertures 224 extending part way through the insert 200 can be formed in at least the non-raised areas.

In the embodiments illustrated in FIGS. 8-10, the raised areas 212 are substantially linear. As illustrated, the raised areas 212 are also substantially parallel to one another. In other embodiments, the raised areas 212 can have different configurations such as linear, but intersecting, curved, or otherwise non-linear segments.

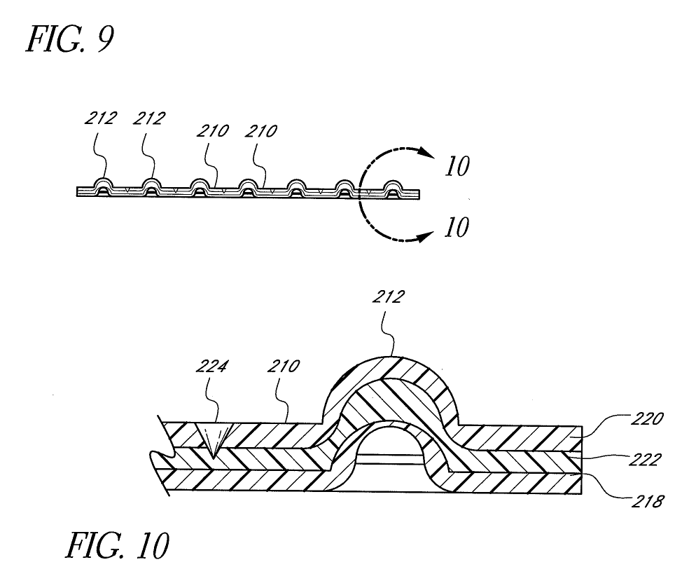

As illustrated in FIG. 9, the insert can comprise recesses on a lower surface corresponding to the raised areas 212 on the upper surface. Similar to the embodiments discussed above, in other embodiments, the lower surface of the insert can be substantially flat, and, in still other embodiments of insert, the lower surface of the insert can have raised ribs.

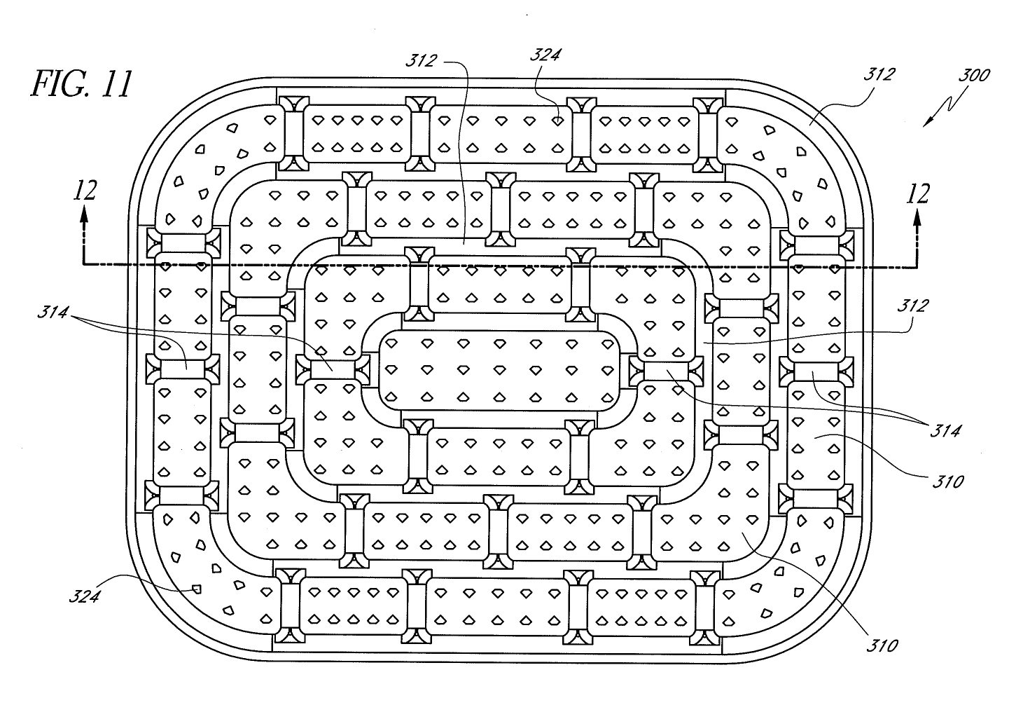

With reference to FIG. 10, an expanded cross-sectional view of the insert 200 is illustrated. In the illustrated embodiment, the insert 200 comprises a first or lower layer 218 comprising a generally closed cell foam, a second or middle layer 222 comprising a generally open cell foam, and a third or top layer 220 comprising a generally closed cell foam. The foam layers can comprise materials discussed above with respect to the insert 100 of FIGS. 1-7. In the illustrated embodiment, apertures 224 are formed in the top layer 220, allowing moisture and drippings to pass into the second layer 222 when a food product is placed atop the insert 200. In other embodiments, the insert can have a different multilayer structure such as one of the alternatives discussed above with respect to the insert 100 of FIG. 1. The insert 200 is generally open on a side, such that the middle layer 222 is exposed and oils passing between the insert 200 and a container in which the insert is placed can be absorbed by the second layer 222.

With reference to FIGS. 11-13, another embodiment of absorbent insert is illustrated. In the illustrated embodiment, the insert 300 is configured for placement in a food container comprising a generally rectangular prismatic box. Thus, the insert 300 can have a substantially rectangular surface. With reference to FIG. 11, in the illustrated embodiments, the insert 300 has a generally rectangular surface with rounded corners. It is contemplated that in other embodiments, a generally rectangular insert could have square corners.

Similar to the insert described above with respect to FIG. 1, in the embodiment of FIG. 11, the insert 300 can comprise a plurality of raised areas 312 or ribs and a plurality of non-raised areas 310. As further discussed below, a plurality of apertures 324 extending part way through the insert 300 can be formed in at least the non-raised areas 310.

In the embodiments illustrated in FIGS. 11-13, the raised areas 312 comprise a plurality of concentric substantially rectangular ribs with rounded corners. In the illustrated embodiment, each rectangular rib forming a raised area 312 is substantially concentric with an outer edge of the insert 300. Raised connectors 314 can span adjacent rectangular ribs. Advantageously, the raised connectors 314 can increase the rigidity of the insert 300, thus allowing the insert 300 to support additional weight. In other embodiments, the raised areas 312 can have different configurations. For example, in some embodiments, other the ribs can have different geometries, such as square, oval, circular, triangular, or other figure. In some embodiments, no raised connectors 314 span between adjacent raised areas 312.

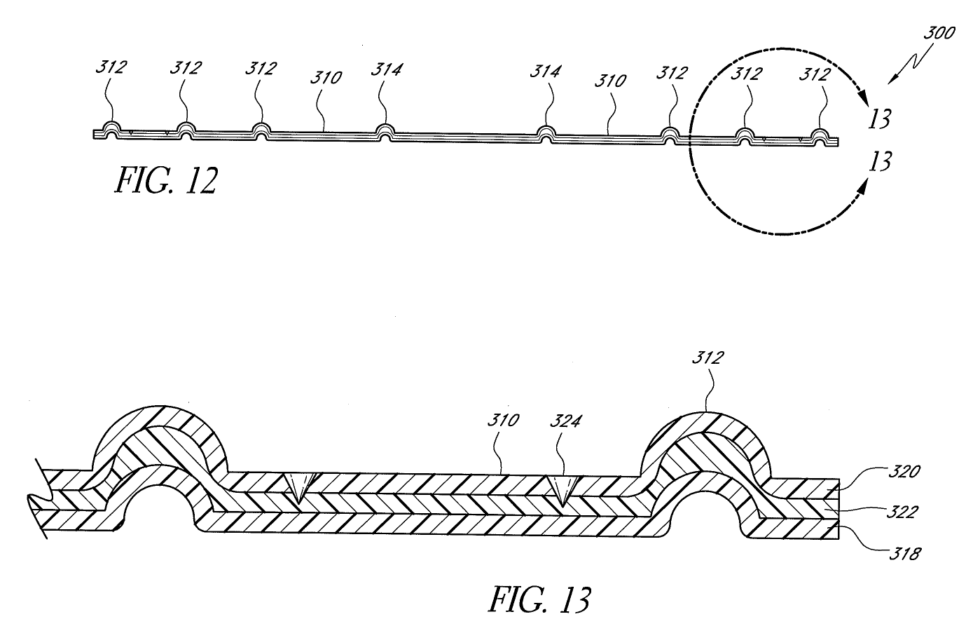

As illustrated in FIG. 12, the insert can comprise recesses on a lower surface corresponding to the raised areas 312 on the upper surface. Similar to the embodiments discussed above, in other embodiments, the lower surface of the insert can be substantially flat, and, in still other embodiments of insert, the lower surface of the insert can have raised ribs.

With reference to FIG. 13, an expanded cross-sectional view of the insert 300 is illustrated. In the illustrated embodiment, the insert 300 comprises a first or lower layer 318 comprising a generally closed cell foam, a second or middle layer 322 comprising a generally open cell foam, and a third or top layer 320 comprising a generally closed cell foam. The layers can comprise materials discussed above with respect to the insert 100 of FIGS. 1-7. Apertures 324 are formed in the top layer 320, allowing moisture and drippings to pass into the second layer 322 when a food product is placed atop the insert 300. In other embodiments, the insert can have a different multilayer structure such as one of the alternatives discussed above with respect to the insert 100 of FIG. 1. As shown in FIG. 13, in some embodiments, the insert 300 can be generally open on a side edge, such that the middle layer 322 is exposed and oils passing between the insert 300 and a container in which the insert is placed can be absorbed by the second layer 322.

Although these inventions have been disclosed in the context of certain preferred embodiments and examples, it will be understood by those skilled in the art that the present inventions extend beyond the specifically disclosed embodiments to other alternative embodiments and/or uses of the inventions and obvious modifications and equivalents thereof. In addition, while a number of variations of the inventions have been shown and described in detail, other modifications, which are within the scope of this inventions, will be readily apparent to those of skill in the art based upon this disclosure. It is also contemplated that various combinations or sub-combinations of the specific features and aspects of the embodiments may be made and still fall within the scope of the inventions. Accordingly, it should be understood that various features and aspects of the disclosed embodiments can be combined with or substituted for one another in order to form varying modes of the disclosed inventions. Thus, it is intended that the scope of the present inventions herein disclosed should not be limited by the particular disclosed embodiments described above, but shall be determined only in accordance with a fair reading of the claims.

What is claimed is:

1. A foam insert for a food container comprising:
a first layer comprised generally of a closed cell foam;
a second layer comprised generally of an open cell foam; and
a third layer comprised generally of a closed cell foam, the third layer comprising a plurality of apertures formed therethrough;
wherein the second layer is positioned between the first and third layers; and
wherein the foam insert is sized and configured to be removably inserted into the food container.

2. The foam insert of claim 1, further comprising a plurality of raised areas and a plurality of non-raised areas.

3. The foam insert of claim 2, wherein the apertures are formed at least in the non-raised areas.

4. The foam insert of claim 2, further comprising a plurality of recessed areas and a plurality of non-recessed areas.

5. The foam insert of claim 1, further comprising a plurality of recessed areas and a plurality of non-recessed areas.

6. The foam insert of claim 1, wherein the apertures are generally evenly distributed on the third layer.

7. The foam insert of claim 6, wherein the third layer has a surface area and the third layer comprises approximately two apertures per square inch of surface area.

8. The foam insert of claim 1, wherein each of the apertures has an area between approximately 0.025 in² and 0.125 in².

9. The foam insert of claim 1, wherein at least the third layer of the insert is resistant to heat at temperatures greater than approximately 120° F.

10. The foam insert of claim 1, wherein the foam insert has an open outer edge such that the outer edge of the insert presents at least a portion of the second layer.

11. The foam insert of claim 1, wherein the second layer is absorbent.

12. The foam insert of claim 1, wherein the second layer includes a surfactant.

13. A food storage system comprising:
a food container; and
a removable absorbent insert sized and configured to fit within the food container, the insert comprising:
a first layer comprised generally of a generally heat resistant material;
and
a second layer comprised generally of an absorbent material;
wherein the first layer comprises a plurality of apertures therethrough.

14. The food storage system of claim 13, wherein the first layer comprises a closed cell foam material.

15. The food storage system of claim 13, wherein the second layer comprises an open cell foam material.

16. The food storage system of claim 13, wherein the food container comprises a body and a lid.

17. The food storage system of claim 13, wherein the food container comprises a bucket having a generally circular base.

18. The food storage system of claim 17, wherein the insert has a generally circular profile.

19. The food storage system of claim 13, wherein the insert further comprises a plurality of raised areas and a plurality of non-raised areas.

20. The food storage system of claim 19, wherein the apertures are formed at least in the non-raised areas of the insert.

21. The food storage system of claim 13, wherein the insert further comprises a third layer comprised generally of a closed cell foam.

22. The food storage system of claim 13, wherein the insert has an open outer edge such that the second layer is exposed at the outer edge of the insert.

23. The food storage system of claim 22, wherein the insert is sized and configured such that a gap remains between the food container and outer edge of the insert when the insert is positioned in the food container.
